(19) United States
(12) Patent Application Publication
(10) Pub. No.: US 2023/0304166 A1
(43) Pub. Date: Sep. 28, 2023

(54) CHEMICAL CALCIUM HYDROXIDE MANUFACTURING FOR CEMENT PRODUCTION USING ELECTROCHEMICAL SEPARATION DEVICES

(71) Applicant: The Regents of the University of California, Oakland, CA (US)

(72) Inventors: Iryna Zenyuk, Irvine, CA (US); Andrea Perego, Irvine, CA (US); Mo Li, Irvine, CA (US); Devashish S. Kulkarni, Irvine, CA (US)

(73) Assignee: The Regents of the University of California, Oakland, CA (US)

(21) Appl. No.: 18/041,189

(22) PCT Filed: Aug. 11, 2021
(86) PCT No.: PCT/US2021/045612

§ 371 Date: Feb. 9, 2023

Related U.S. Application Data
(60) Provisional application No. 63/064,327, filed on Aug. 11, 2020.

(51) Int. Cl. C25B 1/16; C25B 9/21; C25B 13/08; C25B 11/077; C25B 11/065; C25B 11/081; C25B 11/032; C25B 15/08; C04B 7/48; C25B 13/02

(52) U.S. Cl. CPC C25B 1/16; C25B 9/21; C25B 13/08; C25B 11/077; C25B 11/065; C25B 11/081; C25B 11/032; C25B 15/083; C04B 7/48; C25B 13/02; C25B 1/04

(57) ABSTRACT

An electrochemical method for producing calcium hydroxide includes dissolving a calcium precursor in a first solution in contact with a first electrode to produce Ca²⁺ ions, transporting the Ca²⁺ ions across a first membrane from the first solution into a second solution using a first electrochemical potential, producing hydroxide ions at a second electrode, transporting the hydroxide ions across a second membrane into the second solution using a second electrochemical potential, and precipitating calcium hydroxide from the second solution.

### CROSS-REFERENCE TO RELATED PATENT APPLICATIONS

This application claims the benefit of priority to U.S. Provisional Patent Application No. 63/064,627, filed Aug. 11, 2020, which is incorporated herein by reference in its entirety.

### GOVERNMENT RIGHTS

The subject matter of the present disclosure was made with government support under Award No. 2036354, awarded by the National Science Foundation to the University of California, Irvine. The government has certain rights in the invention.

### TECHNICAL FIELD

The present application generally relates to the manufacture of cement, methods of production, and devices for the same. More specifically, it is related to a chemical process for producing calcium hydroxide for cement manufacturing using electrochemical reactors with improved energy efficiency and reduced CO₂ emissions.

### BACKGROUND

Ordinary Portland Cement (“OPC”) is a synthetic material made by high temperature firing and grinding of limestone and clay, or other calcium- and silicon-containing materials, to a temperature of about 1450° C. in a rotary kiln. This high-temperature process produces clinker nodules through partial fusion. The clinker is mixed with a small amount of calcium sulfate (gypsum) and finely ground to produce the OPC.

The reactions during cement manufacturing may be grouped into three stages. Stage 1: at temperatures below 1300° C., the principal reactions involve the decomposition of calcite ((Ca(CO)₃) and clay minerals, and the reaction of calcite or lime with quartz and clay mineral decomposition products to form belite (Ca₂SiO₄), aluminate (Ca₃AlO₅) and ferrite (Ca₄Al₂Fe₂O₁₀). Stage 2: at 1300-1450° C., a melt forms mainly from the aluminate and ferrite. In the presence of the melt, belite and nearly all of the lime react to form alite (Ca₃SiO₅). The mixture nodulizes to form the cement clinker. Stage 3: during the cooling stage, the liquid crystallizes to form mainly aluminate and ferrite, and polymorphic transitions of the alite and belite occur.

As a result of this manufacturing process, cement clinker normally contains four major phases, in order of abundance: alite, belite, aluminate, and ferrite. In cement chemistry notation, where oxides are abbreviated as a single capital letter, these are written as C₃S, C₂S, C₃A, and C₄AF. Alite is a tricalcium silicate that constitutes 50-70% of Portland cement clinkers. It reacts relatively quickly with water and is responsible for the rapid strength gain of Portland cement concrete, especially in the first four weeks of the curing process. Belite is a dicalcium silicate that constitutes 15-30% of cement clinker. It reacts slowly with water, and contributes little to the strength during the first four weeks. However, it adds substantially to the late-age strength gain.

The hydration of alite and belite leads to products such as crystalline calcium hydroxide (Ca(OH)₂ or “CH”) and calcium silicate hydrate (C-S-H) gel, a phase with a poorly crystalline or amorphous structure and variable stoichiometry. C-S-H is the binding phase primarily responsible for the mechanical strength and durability of the concrete in a various environments. Tricalcium aluminate (C3A) constitutes 5-10% of OPC clinker. It reacts with water and gypsum to form ettringite, a crystalline paste that is stable only when the supply of sulfate from the gypsum is sufficient. When the available gypsum is exhausted, ettringite transforms to crystalline monosulfoaluminate (Ca₄Al₂(SO₄)(OH)₁₂·6H₂O). Tetracalcium aluminoferrite (C4AF) constitutes 5-15% of cement clinker. It reacts with water and gypsum to form similar phases as ettringite and monosulfoaluminate where some aluminum-occupied sites are replaced by iron.

The hydration of OPC is initially rapid, dominated by alite reaction, followed by a shoulder peak where a secondary formation of ettringite occurs, and subsequent broad peak corresponding to the formation of AFm phase. Afterward, the process proceeds slowly as it becomes diffusion-limited, leading to a continued gain in strength over time.

OPC was first patented in 1824, and it has been commercially produced since shortly thereafter, with the introduction of the rotary kiln. Since then, it has been used in a form similar to its current one, and its manufacturing method has not fundamentally changed over the years. The energy efficiency of cement kilns was improved in the 1970's, leading to a 40% reduction in the kiln fuel energy consumption to produce cement. To date, most efforts to reduce CO₂ emissions, have focused on the use of supplementary cementitious materials, but those only provide modest CO₂ reductions. Other approaches, such as Calera technology to capture CO from fossil fuel power plants and sequester the carbon in building materials or geologically stable substances, are controversial as they require the building of vast infrastructures and the result remain to be proven. A manufacturing approach that can drastically reduce the energy consumption and CO₂ emission associated with cement production, remains an unmet need in the industry.

Portland cement concrete is the most widely used man-made material in the world. More than one ton of concrete is produced annually per person on Earth. Cement production contributes to about 8% (2.8 Gtons/year) of carbon dioxide emissions and accounts for 5% of industrial energy consumption globally. Since World War II, cement production has increased 30 fold, and 4 fold since 1990, which is a more rapid increase than global fossil energy production.

In conventional manufacturing processes of Portland cement, energy input from fossil fuels is used to calcine limestone (CaCO₃), where CaCO₃ is decomposed into CaO and CO₂. CO₂ emission is from fossil fuel combustion and decomposition of CaCO₃ in the kiln. Fossil fuel combustion is needed to heat the raw materials to calcine (900° C.) and sinter (1500° C.). About 1 ton of CO₂ is released for every ton of Portland cement produced. Thus, methods for producing portlandite (Ca(OH)₂), the most important component of Portland cement, which reduce overall CO₂ emissions by reducing or eliminating the use of fossil fuels for heating raw materials and limiting or eliminating production of CO₂ from decomposition of CaCO₃, are of great commercial interest.

### SUMMARY

In one aspect, which may be combined with any other aspect or embodiment, the present disclosure relates to an electrochemical method for producing calcium hydroxide, comprising, consisting essentially of, or consisting of: (a) dissolving a calcium precursor in a first solution in contact with a first electrode to produce Ca²⁺ ions; (b) transporting the Ca²⁺ ions across a first membrane from the first solution into a second solution using a first electrochemical potential; (c) producing hydroxide ions at a second electrode; (d) transporting the hydroxide ions across a second membrane into the second solution using a second electrochemical potential; and (e) precipitating calcium hydroxide from the second solution. In some embodiments, the calcium precursor comprises, consists essentially of, or consists of calcium carbonate.

In some embodiments, the first electrode is an anode. In some embodiments, the first solution has an acidic pH. In some embodiments, the first membrane is a polymer electrolyte membrane. In some embodiments, the first electrochemical potential is produced by water electrolysis or chlorine evolution.

In some embodiments, the second electrode is a cathode. In some embodiments, the second membrane comprises an anion exchange membrane. In some embodiments, the second electrochemical potential is produced by water electrolysis or carbon dioxide electrolysis.

In some embodiments, the second solution is a salt solution. In some embodiments, the second solution flows through a channel between the first membrane and the second membrane.

In some embodiments, an electrochemical method for producing calcium hydroxide according to the present disclosure further comprises: (f) collecting one or more by-products from the production of the first electrochemical potential or production of the second electrochemical potential. In some embodiments, the one or more by-products comprises, consists essentially of, or consists of hydrogen gas, carbon monoxide gas, or chlorine gas.

In some embodiments, the first electrochemical potential is produced by oxidation of one or more hydrogenated fuels. In some embodiments, the one or more hydrogenated fuels comprises, consists essentially of, or consists of methanol, ammonia, hydrazine, or sodium borohydride. In some embodiments, the one or more hydrogenated fuels is in a liquid state.

In some embodiments, current is supplied to the anode and/or the cathode using a renewable energy source.

In another aspect, which may be combined with any other aspect or embodiment, the present disclosure relates to a method of producing a cement clinker, comprising, consisting essentially of, or consisting of: (a) providing a calcium hydroxide produced according to a method comprising: (i) dissolving a calcium precursor in a first solution in contact with a first electrode to produce Ca²⁺ ions; (ii) transporting the Ca²⁺ ions across a first membrane from the first solution into a second solution using a first electrochemical potential; (iii) producing hydroxide ions at a second electrode; (iv) transporting the hydroxide ions across a second membrane into the second solution using a second electrochemical potential; and (v) precipitating calcium hydroxide from the second solution; and (b) combining the calcium hydroxide with oxides and/or silicates to produce the cement clinker. In some embodiments, the calcium precursor comprises, consists essentially of, or consists of calcium carbonate.

In some embodiments, the first electrode is an anode. In some embodiments, the first solution has an acidic pH. In some embodiments, the first membrane comprises, consists essentially of, or consists of a polymer electrolyte membrane, bipolar membrane, or anion exchange membrane. In some embodiments, the first electrochemical potential is produced by water electrolysis or chlorine evolution.

In some embodiments, the second electrode is a cathode. In some embodiments, the second membrane comprises, consists essentially of, or consists of an anion exchange membrane, bipolar membrane, or a polymer electrolyte membrane. In some embodiments, the second electrochemical potential is produced by water electrolysis or carbon dioxide electrolysis.

In some embodiments, the second solution is a salt solution. In some embodiments, the second solution flows through a channel between the first membrane and the second membrane.

In some embodiments, an electrochemical method for producing a calcium hydroxide, as part of a method for producing a cement clinker, further comprises: (vi) collecting one or more by-products from the production of the first electrochemical potential or production of the second electrochemical potential. In some embodiments, the one or more by-products comprise hydrogen gas, carbon monoxide gas, or chlorine gas.

In some embodiments, the first electrochemical potential is produced by oxidation of one or more hydrogenated fuels. In some embodiments, the one or more hydrogenated fuels comprises, consists essentially of, or consists of methanol, ammonia, hydrazine, or sodium borohydride. In some embodiments, the one or more hydrogenated fuels is in a liquid state.

In some embodiments, current is supplied to the anode and/or the cathode using a renewable energy source.

In another aspect, which may be combined with any other aspect or embodiment, the present disclosure relates to an apparatus for electrochemical production of calcium hydroxide, the apparatus comprising, consisting essentially of, or consisting of: (a) an anode; (b) a cathode; and (c) a flow-through channel between the anode and the cathode, wherein a first membrane or separator is between the anode and the flow-through channel and a second membrane or separator is between the cathode and the flow-through channel.

In some embodiments, an apparatus for electrochemical production of calcium hydroxide further comprises a flow field in contact with a first side of the anode, wherein the flow field comprises an anode inlet and an anode outlet configured to supply a first solution to the anode.

In some embodiments, an apparatus for electrochemical production of calcium hydroxide further comprises a channel inlet and a channel outlet, wherein the channel inlet is configured to supply a flow of a second solution to the channel and the channel outlet is configured to direct the flow of the second solution and precipitated calcium hydroxide away from the channel.

In some embodiments, an apparatus for electrochemical production of calcium hydroxide further comprises a flow field in contact with a first side of the cathode, wherein the flow field comprises a cathode inlet and a cathode outlet configured to supply a third solution to the cathode.

In some embodiments, the first membrane comprises, consists essentially of, or consists of a polymer electrolyte membrane, bipolar membrane, or an anion exchange membrane. In some embodiments, the second membrane comprises, consists essentially of, or consists of a polymer electrolyte membrane or an anion exchange membrane.

In some embodiments, the anode comprises a first catalyst. In some embodiments, the first catalyst comprises, consists essentially of, or consists of IrOx (e.g., IrO₂). In some embodiments, the cathode comprises a second catalyst. In some embodiments, the second catalyst comprises, consists essentially of, or consists of a platinum group metal. In some embodiments, the second catalyst comprises, consists essentially of, or consists of Pt/C.

In some embodiments, the anode and/or the cathode comprises a gas diffusion layer. In some embodiments, the channel has a length, measured between the first membrane or separator and the second membrane or separator, of about 100 μm to about 10 mm.

In another aspect, which may be combined with any other aspect or embodiment, the present disclosure relates to an apparatus comprising, consisting essentially of, or consisting of one or more electrolyzers for calcium carbonate conversion to calcium hydroxide, which will further react with SiO₂ or other oxides to produce cement clinker. In some embodiments, the one or more electrolyzers is used as an electrochemical separation device to produce a gradient in pH across the anode and the cathode and/or between the anode and the cathode. In some embodiments, the pH gradient enables CaCO₃ dissolution in acidic media (e.g., on either anode or cathode) and Ca(OH)₂ precipitation in alkaline media (e.g., in a buffer flow-channel).

In some embodiments the apparatus may comprise combinations of different anode and cathode redox couples which can be used for Ca(OH)₂ manufacturing. In some embodiments, conversion of CaCO₃ to Ca(OH)₂ is chemical in nature (as CaCO₃ solubility is a limiting step), and calcium hydroxide production within the electrolyzers does not depend on electrochemical current density. In some embodiments, reactions on anode and cathode of the electrolyzers are thermodynamically and kinetically favorable for production of desired value-added products and at the same time produce Ca(OH)₂ as a chemical by-product.

### BRIEF DESCRIPTION OF THE DRAWINGS

These and other aspects and features of the present embodiments will become apparent to those ordinarily skilled in the art upon review of the following description of specific embodiments in conjunction with the accompanying figures.

FIG. 1 is a conceptual schematic of a method for producing calcium hydroxide according to the present disclosure, which uses electrochemical methods for producing calcium hydroxide and may rely on renewable energy sources, reducing the overall CO₂ production and producing value-added by-products.

FIG. 2 is a schematic showing calcium ion and hydroxide ion distribution across an apparatus for producing calcium hydroxide, according to the examples, along with four exemplary proposed configurations for electrolyzers for Ca(OH)₂ production. The potentials reported in FIG. 2 are theoretical and do not take into account kinetics and Donnan potential.

FIG. 3 is a schematic illustration of a general electrolyzer design according to the examples.

FIG. 4A is a schematic of ion transport within selected domains of an electrolyzer for Configuration 1 (bipolar water electrolyzer), also showing the pH distribution from anode to cathode and applied voltage profile, according to the examples.

FIG. 4B is a schematic of ion transport within selected domains of an electrolyzer for Configuration 2 (bipolar CO₂ reduction electrolyzer), also showing the pH distribution from anode to cathode and applied voltage profile, according to the examples.

FIG. 5 illustrates preliminary model results for proton, hydroxide, and calcium ion distribution across the electrolyzer components, according to the examples.

FIG. 6 illustrates preliminary model results for reaction rate of Ca²⁺ as a function of Ca²⁺ solubility, according to the examples.

FIG. 7A is an exploded view of one embodiment of an electrolyzer design, where all the components are marked, FIG. 7B is a 3D rendering of an assembled electrolyzer, where the reactants and products in and out are shown, FIG. 7C is an assembled 5 cm² electrolyzer in the laboratory, and FIG. 7D is a semi-assembled cell, according to the examples.

FIG. 8A shows a linear sweep voltammetry plot measured for three different cells (cells 4 and 5=60° C.; cell 6=40° C.) in an apparatus for producing Ca(OH)₂ corresponding to Configuration 1 (bipolar water electrolyzer). The inset shows a photograph a disassembled cell with Ca(OH)₂ precipitate in the channel. FIG. 8B shows potential profiles of the cells operating for 2 hours at constant current density (cell 4=80 mA/cm²; cell 5=40 mA/cm²; cell 6=20 mA/cm²). FIG. 8C shows precipitate yield for the three cells.

FIG. 9 shows a linear sweep voltammetry plot measured for a cell in an apparatus for producing Ca(OH)₂ corresponding to Configuration 2 (CO₂ electrolysis). The inset shows a photograph of Ca(OH)₂ precipitate collected from the channel.

FIG. 10 show a Fourier Transform Infrared Spectrum of the precipitate from FIG. 9 (inset).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

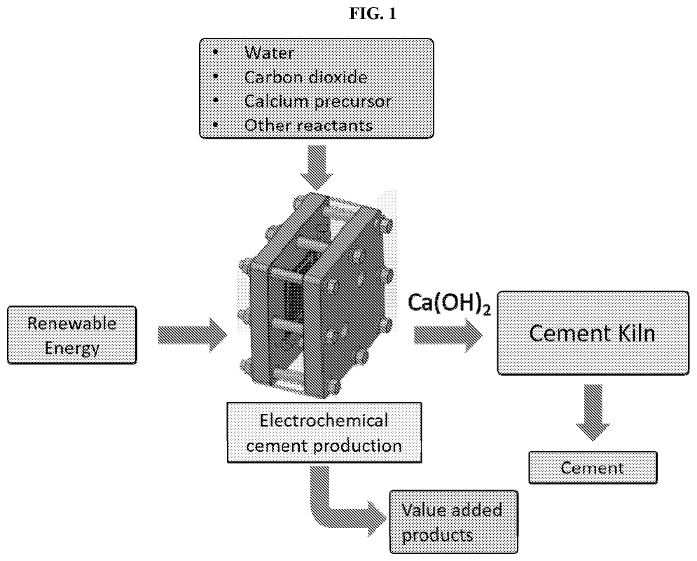

In response to the unmet need for greener, more energy efficient production of cement, the present inventors have developed electrochemical process for the production of calcium hydroxide, an essential component of OPC. Referring to FIG. 1, described herein are devices, apparatuses, and processes for the low-temperature (e.g. 40-80° C.) conversion of Ca(CO)₃ into Ca(OH)₂ using renewable electricity as an input. The Ca(OH)₂ thus produced may be used to synthesize cement clinker.

Referring still to FIG. 1, the chemical conversion occurs in an electrochemical electrolyzer, that is based upon an ion separation platform with bipolar membranes, producing value-added chemicals (e.g., H₂, CO, or Cl₂). The electrochemical-based approach requires less energy to generate CaO from Ca(OH)₂, compared to that from the conventional CaCO₃ calcination. The resulting CaO can readily react with SiO₂ to create alite, as well as other important constituents of Portland cement. The manufacturing process described herein also decreases CO₂ emissions through the use of renewable electricity, lower-temperature manufacturing, and CO₂ capture and reuse in the electrolyzer.

As set forth above, Portland cement concrete is the most widely used man-made material in the world, but approximately one ton of CO₂ is released for every ton of Portland cement produced in conventional methods. The present disclosure relates to a low-temperature, low-CO₂-footprint approach to substitute one of the critical steps of cement manufacturing (CaCO₃ calcination) with an intermediate step of electrochemical Ca(OH)₂ production before conversion to CaO. One or more electrolyzers facilitating this step (e.g., production of Ca(OH)₂) may be powered by renewable electricity, which, when combined with lower-temperature production of CaO downstream, may offset a significant portion of the fossil fuel CO₂ emissions for CaCO₃ calcination. Furthermore, CO₂-reduction electrolyzers may be used for combined CO₂ capture and Ca(OH)₂ production, further minimizing CO₂ emission from this manufacturing process.

Apparatus for Production of Ca(OH)₂

In one aspect, the present disclosure relates to an apparatus for electrochemical production of calcium hydroxide, the apparatus comprising, consisting essentially of, or consisting of: (a) an anode; (b) a cathode; and (c) a flow-through channel between the anode and the cathode, wherein a first membrane or separator is between the anode and the flow-through channel and a second membrane or separator is between the cathode and the flow-through channel.

Anode

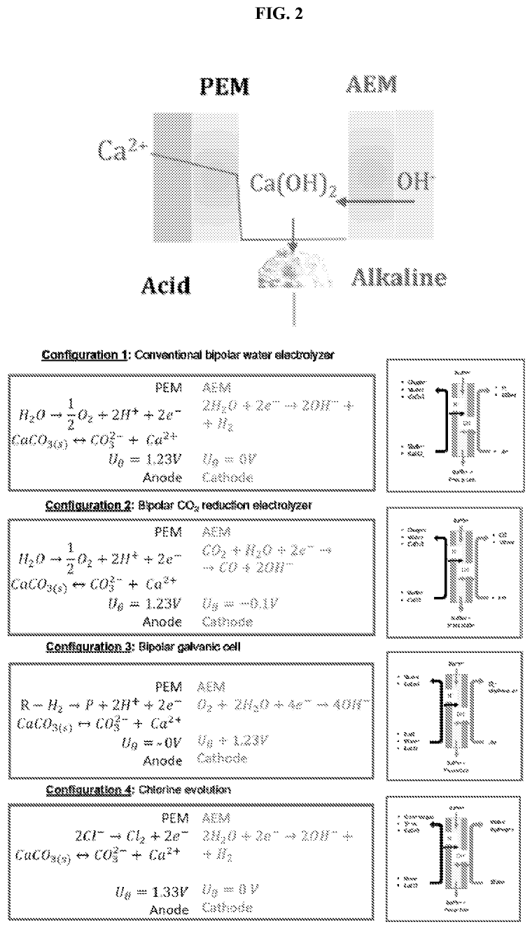

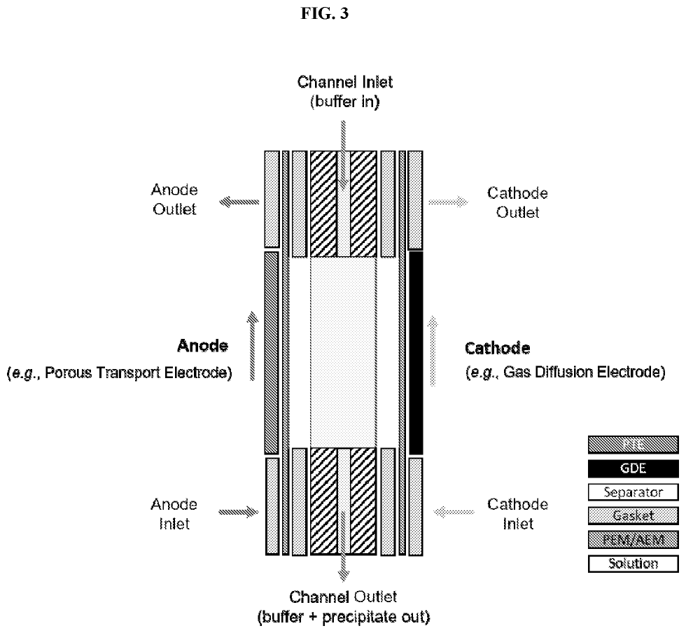

Referring to FIGS. 2 and 3, an apparatus for producing Ca(OH)₂ may comprise an anode capable of facilitating one or more electrochemical reactions that facilitate transport of Ca²⁺ ions across a first membrane or separator. Examples of such electrochemical reactions are shown in FIG. 2. The anode may comprise any suitable material for facilitating an electrochemical reaction and generating an electrochemical potential. In some embodiments the anode may comprise any suitable conductive material (e.g., a metal, such as Ti). In some embodiments the electrochemical reaction may be, by way of non-limiting example, a water electrolysis reaction, which generates oxygen and H⁺ ions, or a chlorine evolution reaction, which generates chlorine gas (Cl₂) from chlorine ions in solution (e.g., a brine solution). In some embodiments, the anode may further comprise a catalyst material (e.g., catalyst layer) capable of catalyzing an electrochemical reaction (e.g., IrOx (e.g., IrO₂)), a platinum group metal, Pt/C, or any other suitable catalyst).

The apparatus may comprise any suitable means for supplying a first solution comprising Ca²⁺ ions to the anode. For example, a first solution may be supplied to the anode by a flow field comprising an anode inlet, which delivers a first solution to the anode. The first solution may flow past the anode and may have any suitable configuration (e.g., serpentine) for maximizing contact of the first solution with the anode. The first solution may be directed away from the anode using an anode outlet.

Cathode

As further shown in FIGS. 2 and 3, an apparatus for producing Ca(OH)₂ may comprise a cathode capable of facilitating one or more electrochemical reactions that facilitate transport of hydroxide ions (OH⁻) across a second membrane or separator into a second solution in a channel between the anode and cathode. In some embodiments the cathode may comprise any suitable conductive material (e.g., a metal, such as Ti). In some embodiments the electrochemical reaction may be, by way of non-limiting example, a water electrolysis reaction, which generates hydrogen gas and hydroxide ions, or a carbon dioxide reduction, which generates hydroxide ions and carbon monoxide gas as a by-product. In some embodiments, the cathode may further comprise a catalyst material (e.g., catalyst layer) capable of catalyzing an electrochemical reaction (e.g., IrOx (e.g., IrO₂), a platinum group metal, Pt/C, copper, silver, C—N—Fe composites, C—N-transition metal composites, Sn, or any other suitable catalyst). Other catalysts may include precious-metal-free (PGM-free) electrocatalysts for oxygen evolution reactions in acidic media or hydrogen evolution reactions in alkaline media. These catalysts include C—N—Fe composites for OER and NiCu and/or NiMo composites for HER.

The apparatus may comprise any suitable means for supplying a third solution, which comprises OH— ions, to the cathode. For example, a third solution may be supplied to the cathode by a flow field comprising an cathode inlet, which delivers a third solution to the cathode. The third solution (which may be a liquid solution or a gas, such as air or a carbon dioxide-containing gas) may flow past the cathode and may have any suitable configuration (e.g., serpentine) for maximizing contact of the third solution with the cathode. The third solution may be directed away from the anode using an cathode outlet.

In embodiments in which the third solution comprises a gas (e.g., carbon dioxide reduction), the cathode may further comprise a gas diffusion layer (GDL). A GDL layer is a porous layer of material that permits gas-phase reactants (e.g., oxygen, hydrogen, carbon dioxide etc.) to diffuse into the catalyst layer(s) (at the anode and/or cathode) (e.g., platinum, titanium, etc.), where the anode or cathode cell reactions occur. A GDL is not particularly limited in terms of the material or materials constituting the GDL. By way of non-limiting example, in some embodiments, the GDL comprises a carbon-based material, such as carbon nanotubes, carbon powder, carbon black, or a carbonaceous fibrous or woven layer, such as carbon cloth or carbon paper, which may comprise a microporous layer. In some embodiments, the GDL may comprise a commercially available material (e.g., Freudenberg H23C6; Freudenberg H32C2; Freudenberg H23C7; SGL 29BC; SGL 22BB; Advcarb MB30; Toray TGP-H-60). Further, a GDL according to the present disclosure may be coated by a hydrophobic material, such as PTFE.

Channel

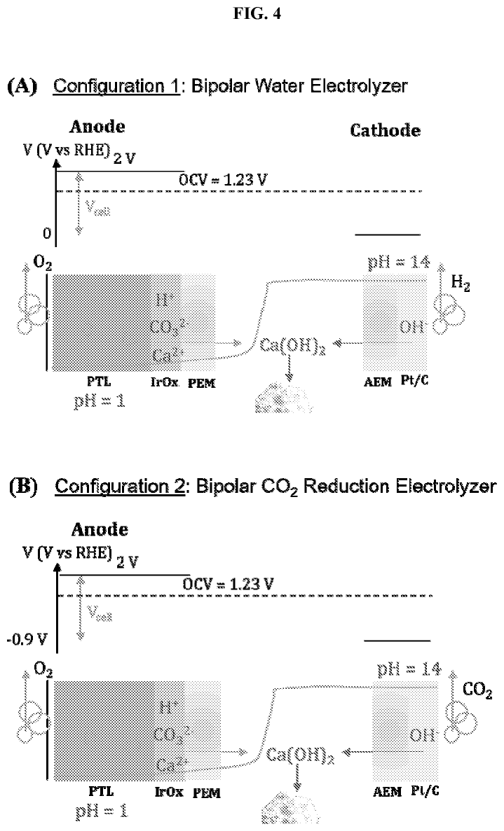

As shown in FIGS. 2 and 4, the Ca²⁺ ions and OH⁻ ions are transported across a first membrane or separator and a second membrane or separator, respectively, into a channel containing a second solution. The channel is between the anode and cathode and their respective first membrane or separator and second membrane or separator. Because calcium ions are insoluble in basic conditions, the combination of calcium ions and hydroxide ions leads to formation of Ca(OH)₂, which precipitates from solution.

As shown in FIG. 3, the channel may be any suitable configuration for producing and precipitating Ca(OH)₂, then removing Ca(OH)₂ from the channel for collection. For instance, the channel may be a flow-through channel with a channel inlet and a channel outlet. The channel may be configured to direct flow of a salt solution (e.g., buffer solution) through the channel, which facilitates the precipitation of Ca(OH)₂ inside the channel.

The channel may be designed to satisfy multiple process requirements, including removal of Ca(OH)₂ precipitate and providing adequate support to the first membrane or separator and/or the second membrane or separator. Accordingly, the channel may be constructed of any suitable material(s) which are sufficiently rigid, chemically inert, corrosion-resistant, and/or alcohol resistant, to meet the above-mentioned process requirements, among others. By way of non-limiting example, the channel may comprise PTFE, PMMA, PET, HDPA, PFA, PVC, CPVC, PEEK, PVDF, PCTFE, ETEE, ECTFE, FEP, PDMS, or polypropylene, copolymers or alloys thereof, or any combination thereof. In particular, a flexible material (e.g., PDMS) may be used to enable mechanical manipulation of the channel to remove obstructions (e.g., precipitated Ca(OH)₂) without disrupting operation or compromising the structural integrity of the apparatus.

The channel may be any suitable width for facilitating diffusion of Ca²⁺ ions away from the first membrane or separator and into the second solution and for facilitating diffusion of OH⁻ ions away from the second membrane or separator and into the second solution. The channel may be of any suitable configuration for facilitating precipitation of Ca(OH)₂ while avoiding obstruction of the channel. For example, the channel may have an open configuration, a linear configuration, or a non-linear (e.g., serpentine) configuration. Similarly, the channel may be open, comprise a porous material, or may comprise one or more dividers.

The channel should have a width that permits sufficient flow of a second solution to facilitate transport of any Ca(OH)₂ precipitate out of the channel (e.g., through a channel outlet) where it may be collected for subsequent industrial use (e.g., in production of cement clinker), without obstructing the channel. In some embodiments, the channel has a width of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.5 mm, at least about 2 mm, at least about 2.5 mm, at least about 3 mm, at least about 3.5 mm, at least about 4 mm, at least about 4.5 mm, at least about 5 mm, at least about 6 mm, at least about 7 mm, at least about 8 mm, at least about 9 mm, at least about 10 mm, or any range or value therein between.

Second Solution

The second solution inside the channel may be a salt solution (e.g., a buffer solution) with high ionic strength to enable Ohmic contact between anode and cathode but at the same time to facilitate Ca(OH)₂ precipitation and carry out Ca(OH)₂ precipitate from the channel. In some embodiments, the second solution may be, e.g., a 0.1 M KCl solution.

First Membrane

In some embodiments, the Ca²⁺ ions in solution may be transported across a first membrane into a second solution in the channel. The first membrane may comprise any suitable material for facilitating selective ion transport from the first solution (which may be acidic) into a second solution, which may have a higher pH than the first solution. In some embodiments, the first membrane may comprise a polymer electrolyte membrane (PEM), anion exchange membrane (AEM), or bipolar membrane (BPM). In some embodiments, the membrane may comprise any suitable material(s) to facilitate Ca²⁺ ion transport from higher Ca²⁺ concentration to lower Ca²⁺ concentration. In some embodiments, the polymer electrolyte membrane may comprise perfluorosulfonic ionomers (e.g., NAFION®). In some embodiments, an anion exchange membrane may comprise a commercially-available AEM (e.g., Fumasep FAS-PET-75, FAS-PET-130; Fumasep FAS-30, FAS-50; Fumasep FAD-55, FAD-PET-75; Fumasep FAA-3-50, FAA-3-PK-75, FAA-3-PK-130; Sustainion X37-50, X37-FA; Xergy Xion Durion™ LMW-AEM-215-30; TM1 DURION Grade-AEM; Xergy Pention-AEM-272-05; PiperION Anion Exchange Membrane). In some embodiments, a bipolar membrane (BPM) may comprise a commercially-available BPM (e.g., Fumasep FBM; Xion BPM-Aquivion-870-Durion-LMW; Xion BPM-Dyneon-725-Durion-LMW; Xion BPM-Nafion-1000-Pention-72-15CL).

Second Membrane

In some embodiments, the OH⁻ ions in a third solution may be transported across a second membrane into a second solution in the channel. The second membrane may comprise any suitable material for facilitating selective ion transport from the first solution (which may be alkaline) into a second solution, which may have a different pH from the third solution at the cathode. In some embodiments, the second membrane may comprise a polymer electrolyte membrane (PEM), an anion exchange membrane (AEM), or a bipolar membrane (BPM, which may be a composite of a PEM and an AEM). In some embodiments, the second membrane may comprise any suitable material(s) to facilitate hydroxide ion transport from the third solution at the cathode to the second solution in the channel. In some embodiments, the polymer electrolyte membrane may comprise perfluorosulfonic ionomers (e.g., NAFION®). In some embodiments, an anion exchange membrane may comprise a commercially-available AEM (e.g., Fumasep FAS-PET-75, FAS-PET-130; Fumasep FAS-30, FAS-50; Fumasep FAD-55, FAD-PET-75; Fumasep FAA-3-50, FAA-3-PK-75, FAA-3-PK-130; Sustainion X37-50, X37-FA; Xergy Xion Durion™ LMW-AEM-215-30; TM1 DURION Grade-AEM; Xergy Pention-AEM-272-05; PiperION Anion Exchange Membrane). In some embodiments, a bipolar membrane (BPM) may comprise a commercially-available BPM (e.g., Fumasep FBM; Xion BPM-Aquivion-870-Durion-LMW; Xion BPM-Dyneon-725-Durion-LMW; Xion BPM-Nafion-1000-Pention-72-15CL).

Electrochemical Methods for Ca(OH)₂ Production

In one aspect, the present disclosure relates to an electrochemical method for producing calcium hydroxide, comprising: (a) dissolving a calcium precursor in a first solution in contact with a first electrode to produce Ca²⁺ ions; (b) transporting the Ca²⁺ ions across a first membrane from the first solution into a second solution using a first electrochemical potential; (c) producing hydroxide ions at a second electrode; (d) transporting the hydroxide ions across a second membrane into the second solution using a second electrochemical potential; and (e) precipitating calcium hydroxide from the second solution.

Calcium Precursor

The calcium precursor may be any suitable compound that dissolves in a first solution to produce Ca²⁺ ions. In some embodiments, the calcium precursor is calcium carbonate (CaCO₃). However, the calcium precursor is not limited to calcium carbonate and may include, by way of non-limiting example, calcium chloride, calcium bromide, calcium fluoride, calcium iodide, calcium citrate, calcium lactate, calcium gluconate, calcium lactate gluconate, calcium phosphate dibasic, calcium phosphate tribasic, calcium pyrophosphate, calcium sulfate, calcium nitrate, calcium acetate, or any other suitable calcium precursor.

First Solution

In some embodiments, the calcium precursor may be insoluble under basic conditions, so the calcium precursor may be dissolved in an acidic solution. In some embodiments the pH of the first solution may be less than about 7, less than about 6.5, less than about 6.0, less than about 5.5, less than about 5.0, less than about 4.5, less than about 4.0, less than about 3.5, less than about 3.0, less than about 3.0, less than about 2.5, less than about 2.0, less than about 1.5, less than about 1.0, or any range or value therein between. In some embodiments, the pH of the first solution may be about 6.9, about 6.8, about 6.7, about 6.6, about 6.5, about 6.4, about 6.3, about 6.2, about 6.1, about 6.0, about 5.9, about 5.8, about 5.7, about 5.6, about 5.5, about 5.4, about 5.3, about 5.2, about 5.1, about 5.0, about 4.9, about 4.8, about 4.7, about 4.6, about 4.5, about 4.4, about 4.3, about 4.2, about 4.1, about 4.0, about 3.9, about 3.8, about 3.7, about 3.6, about 3.5, about 3.4, about 3.3, about 3.2, about 3.1, about 3.0, about 2.9, about 2.8, about 2.7, about 2.6, about 2.5, about 2.4, about 2.3, about 2.2, about 2.1, about 2.0, about 1.9, about 1.8, about 1.7, about 1.6, about 1.5, about 1.4, about 1.3, about 1.2, about 1.1, about 1.0, or any range or value therein between.

First Membrane

In some embodiments, the Ca²⁺ ions in solution may be transported across a membrane into a second solution. The first membrane may comprise any suitable material for facilitating selective ion transport from the first solution (which may be acidic) into a second solution, which may have a higher pH than the first solution. In some embodiments, the first membrane may comprise a polymer electrolyte membrane (PEM), anion exchange membrane (AEM), or bipolar membrane (BPM). In some embodiments, the membrane may comprise any suitable material(s) to facilitate Ca ion transport from higher Ca²+ concentration to lower Ca²⁺ concentration. In some embodiments, the polymer electrolyte membrane may comprise perfluorosulfonic ionomers (e.g., NAFION®). In some embodiments, an anion exchange membrane may comprise a commercially-available AEM (e.g., Fumasep FAS-PET-75, FAS-PET-130; Fumasep FAS-30, FAS-50; Fumasep FAD-55, FAD-PET-75; Fumasep FAA-3-50, FAA-3-PK-75, FAA-3-PK-130; Sustainion X37-50, X37-FA; Xergy Xion Durion™ LMW-AEM-215-30; TM1 DURION Grade-AEM; Xergy Pention-AEM-272-05; PiperION Anion Exchange Membrane). In some embodiments, a bipolar membrane (BPM) may comprise a commercially-available BPM (e.g., Fumasep FBM; Xion BPM-Aquivion-870-Durion-LMW; Xion BPM-Dyneon-725-Durion-LMW; Xion BPM-Nafion-1000-Pention-72-15CL).

Second Membrane

In some embodiments, the OH⁻ ions in a third solution may be transported across a second membrane into a second solution in the channel. The second membrane may comprise any suitable material for facilitating selective ion transport from the first solution (which may be alkaline) into a second solution, which may have a different pH from the third solution at the cathode. In some embodiments, the second membrane may comprise a polymer electrolyte membrane (PEM), an anion exchange membrane (AEM), or a bipolar membrane (BPM, which may be a composite of a PEM and an AEM). In some embodiments, the second membrane may comprise any suitable material(s) to facilitate hydroxide ion transport from the third solution at the cathode to the second solution in the channel. In some embodiments, the polymer electrolyte membrane may comprise perfluorosulfonic ionomers (e.g., NAFION®). In some embodiments, an anion exchange membrane may comprise a commercially-available AEM (e.g., Fumasep FAS-PET-75, FAS-PET-130; Fumasep FAS-30, FAS-50; Fumasep FAD-55, FAD-PET-75; Fumasep FAA-3-50, FAA-3-PK-75, FAA-3-PK-130; Sustainion X37-50, X37-FA; Xergy Xion Durion™ LMW-AEM-215-30; TM1 DURION Grade-AEM; Xergy Pention-AEM-272-05; PiperION Anion Exchange Membrane). In some embodiments, a bipolar membrane (BPM) may comprise a commercially-available BPM (e.g., Fumasep FBM; Xion BPM-Aquivion-870-Durion-LMW; Xion BPM-Dyneon-725-Durion-LMW; Xion BPM-Nafion-1000-Pention-72-15CL).

First Electrochemical Potential and Second Electrochemical Potential

As shown in FIG. 2, electrochemical methods for producing calcium hydroxide according to the present disclosure may use several different electrolyzer concepts that use a variety of different electrochemical reactions at the anode and cathode, and which can address different manufacturing challenges or produce different by-products.

For instance, referring to FIG. 2, Configuration 1 shows water electrolysis at both anode and cathode for oxygen evolution reactions (OER) and hydrogen evolution reactions (HER), respectively. Barriers for Ca(OH)₂ production with Configuration 1 electrolyzers include: (1) cost of materials, as IrOx (e.g., IrO₂) is used for OER in acidic media, and Pt/C is used for HER in alkaline media; (2) high thermodynamic potential is high; (3) slow acidic OER and alkaline HER and high overpotentials.

Configuration 2 offers numerous unique advantages, as it converts CO₂ into useful by-products (e.g., CO) using CO₂ reduction on the cathode side. These CO₂ reduction electrolyzers may show high efficiencies. An additional advantage in this design is the presence of CO₂ in the cathode stream as a humidified gas, where it is reduced at the cathode to CO and other value-added by-products. Further, the presence of CaCO₃ on the anode side may also lead to production of CO₂ at the anode. This configuration permits simultaneous CO₂ reduction and cement production. CO₂ produced from a calcination process carried out in a kiln may be used as an input in the CO₂ reduction electrolysis, further reducing the CO₂ emission footprint of cement production based on Ca(OH)₂ obtained according the methods of this disclosure. Further, a CO₂ reduction electrolyzer with a bipolar membrane has been shown to exhibit high efficiency in literature studies. (See, e.g., M. Mandal, Highly Efficient Cipolar membrane CO₂ Electrolysis, 8 CHEMELECTROCHEM 1448-50 (2021); B. Pribyl-Kranewater et al., Investigation and Optimisation of Operating Conditions for Low-Temperature CO₂ Reduction to CO in a Forward-Bias Bipolar-Membrane Electrolyser, 168 J. ELECTROCHEM. SOC. 043506 (2021); Z. Yan et al., Improving the Efficiency of CO₂ Electrolysis by Using a Bipolar Membrane with a Weak-Acid Cation Exchange Layer, 13 NATURE CHEM. 33-40 (2021).)

In Configuration 3, R and P are generic reactants and products, respectively, where R is a hydrogenated fuel that can be oxidized in acidic environment to produce protons. By way of non-limiting example, hydrogenated fuels may comprise methanol, ammonia, hydrazine, sodium borohydride, and any combination thereof. In some embodiments, these hydrogenated fuels are in a liquid state as they are fed into the cell, which facilitates the transport of calcium ions. In this configuration, the cell is galvanic, as energy is not supplied to the system but instead produced by the system.

Additionally, in Configuration 4, brine (aqueous sodium chloride) is fed into the anode together with CaCO₃. At the anode, the chlorine evolution reaction has more favorable kinetics than oxygen evolution. Further, this Configuration may produce chlorine gas as a useful by-product. Consequently, this approach may represent a viable alternative to Configurations 1 and 2.

Electrolyzer Operation

In some embodiments, an electrolyzer (an apparatus according to the present disclosure) operates as an electrochemical separation device having a pH gradient between the anode and the cathode, including across the channel between the anode and cathode. The gradient allows for CaCO₃ dissolution in acidic media (on either the anode or the cathode) and Ca(OH)₂ precipitation in alkaline media (e.g., in a flow-through channel containing a buffer solution). An advantage of the methods and devices described herein is that reactions on the anode and cathode of an electrolyzer are thermodynamically and kinetically favorable for production of desired value-added products, such as Ca(OH)₂. (See FIG. 2.) The apparatuses and methods described herein require lower temperature and less energy to synthesize cement using the Ca(OH)₂ produced from this process, compared to the conventional cement manufacturing method of high-temperature firing and grinding of limestone and clay.

As discussed above, a wide range of redox couples may be used in the electrolyzer to convert Ca(CO)₃ to Ca(OH)₂ by electrochemical methods. Referring again to FIGS. 2 and 4, the anode and cathode of the apparatus have an acidic and alkaline pH, respectively, but either the anode or the cathode is capable of operating in acidic or alkaline conditions. The CaCO₃ is dissolved in water or acid solution and is then fed into the electrolyzer on the acidic side, which includes a polymer electrolyte membrane (PEM) or bipolar membrane (BPM) that facilitates transport of Ca² into the channel, where there is a pH gradient between the anode and cathode. CaCO₃ dissolution is a function of pH. The precipitation reaction for Ca(OH)₂ occurs in an alkaline environment in the channel between anode and cathode, which permits its removal from the cell. FIG. 2 shows multiple exemplary electrolyzer couples for producing Ca(OH)₂. Other redox couples of interest which may be used for Ca(OH)₂ production are those used in commercial chlor-alkali processes. (See, e.g., K. Li et al., Revisiting Chlor-Alkali Electrolyzers: From Materials to Devices, 27 TRANS. TIANJIN UNIV. 202-16 (2021)).

FIG. 2 illustrates calcium ion distribution in an electrolyzer operated according to Configurations 1-4, though the illustrated calcium ion distribution is not limited to the configurations listed. Using hydrogen evolution reactions (HER) on cathodes comprising PEMs, and oxygen evolution reactions (OER) on anode comprising AEMs, it is possible to take advantage of both fast kinetics of HER and OER in acidic and alkaline environments, respectively. A series of exemplary reactions relevant to the present electrochemical approach (e.g., as described in Configurations 1-4) is shown in Table 1.

TABLE 1
Exemplary Reactions Relevant to Electrochemical
Ca(OH)₂ Production

| | Thermodynamic potential | Eqn. |
|---|---|---|
| Reaction | or equilibrium potential | number |
| 2H₂O → O₂ + 4H⁺ + 4e⁻ | U_{θ} = 1.23 V | (1) |
| 4H₂O + 4e⁻ → 4H₂ + OH⁻ | U_{θ} = −0.4 V | (2) |
| CaCO₃_{₍ₛ₎}↔ CO₃²⁻ + Ca²⁺ | K₁ = 2.04 × 10⁻⁹ | (3) |
| HCO₃⁻ ↔ CO₃²⁻ + H⁺ | K₂ = 1.16 × 10⁻¹⁰ | (4) |
| H₂O + CO₂ ↔ 2HCO₃⁻ + 2H⁺ | K₃ = 6.89 × 10⁻⁷ | (5) |
| H⁺ + OH⁻ ↔ H₂O | K_{w} = 3.3 × 10⁻¹³ | (6) |
| Ca²⁺ 2OH⁻ ↔ 2Ca(OH)₂₍ₛ₎ | K_{Ca} = 7.2 × 10⁵ | (7) |

Calcium carbonate (CaCO₃) has very low solubility in water (e.g., 47 mg/L at normal atmospheric CO₂ partial pressure). Ki in Equation 3 is the solubility product for [Ca²⁺ ][CO₃²⁻] at 80° C. The concentration of calcium ions ([Ca₂+]) increases as solution pH decreases (i.e., becomes more acidic) and as temperature decreases. In an embodiment, the anode feed may include, e.g., 0.1M HClO₄, in which the solubility of CaCO₃ is 5 g/L (50 mol/m³). The pH of the solution increases from 1 to about neutral (e.g., pH 7) as CaCO₃ is introduced into the solution. To form Ca(OH)₂, a major input in alite formation, an alkaline environment is needed, as Ca(OH)₂ precipitation occurs at basic pH. For example, at about pH 12. An electrolyzer with bipolar membranes is suitable for this manufacturing process, as it provides for the anode and cathode to be in either acidic or alkaline environments, respectively, or vice versa.

The following criteria may be used to select the best electrolyzer for Ca(OH)₂ production, depending on the proposed production environment: the amount of Ca(OH)₂ to be produced; Faradaic efficiency of electrolyzer; overall energy efficiency of electrolyzer; durability; and cost and scalability.

The rate of Ca(OH)₂ production is an important design consideration. Because Ca(OH)₂ reactions are homogeneous, increasing solubility and diffusivity will enable swift removal from the cell. Because electrolyzers are used as separation devices for Ca(OH)₂ formation, they should be able to produce their desired by-products (e.g., CO or H₂). The current density conversion into useful products describes Faradaic efficiency. Low current density also results in lower operational cost for electricity. However, lower current densities require larger active areas and larger electrolyzer volumes. Faradaic efficiency is defined as follows:

$${η}_{f} = \frac{mass of desired product}{theoretical mass from {Faraday}^{′} s law} = \frac{{\dot{m}}_{ι}}{{IM}_{i} / nF} \qquad ( 8 )$$

In the above equation, m; is the mass flow-rate of desired product, I is the total current, Mᵢ is molar mass, n is number of electrons and F is Faraday's constant. If all of the applied current density is converted to the desired product, here H₂ or CO, then Faradaic efficiency will be 100%.

Modeling Ca(OH)₂ Production Rate Dependence on Ca²⁺ Availability

A 1D model was built to gain an understanding of a rate-limiting step in the coupled reaction-transport problem. The model is one-dimensional across the electrolyzer and includes the domains shown by FIG. 4, which include cathode catalyst layer (CL) and PEM on the cathode and porous transport layer (PTL), anode CL and AEM on the anode side, in-between cathode and anode is the flow-channel. The model has an isothermal, single-phase and does not account for gas transport (e.g. CO₂, H₂, and O₂ removal), it mainly focuses on the transport and reactions of charged species. FIG. 4 also shows typical applied potentials (>2V) and pH across the electrolyzer.

Species conservation and Poisson-Nernst-Planck were used to characterize transport of charged species:

∇·Jᵢ=Rᵢ (9)

Jᵢ=−Dᵢ∇cᵢ−zᵢuₘFcᵢ∇ϕₗ (10)

∇²ϕₗ=ρᵢ (11)

where J is the molar flux of species (mol/m²s), R is the volumetric reaction rate, D is the diffusion coefficient, c is the concentration, z is the charge number, u is the mobility (which is obtained with Nernst-Einstein relation), F is Faraday's constant, ϕₗ is the ionic potential, and ρᵢ is the space-charge density (C/m³) that includes both mobile ions and also immobile surface groups of SO³⁻ in PEM and —NR₂ in AEM.

The model incorporates the reactions shown in Table 1 above, where equilibrium reaction constants are shown in the second column. Two electrochemical reactions take place at the electrode-electrolyte interface. The remaining reactions are homogeneous and occur in the bulk. For example, an oxygen evolution reaction (OER) may take place at the anode, described with acidic reaction pathway (Equation 1). At the cathode, a hydrogen evolution reaction (“HER”) occurs in alkaline media (Equation 2). In the model, it is assumed that calcium carbonate has completely dissociated according to the reaction described by Equation 3 and has solubility of 5 g/L as it is fed in 0.1 M HClO₄. On the anode side and in the flow-channel, the carbonate and bicarbonate reactions occur, as described by Equations 4-5. Additionally, in the flow-channel, a water dissociation reaction and calcium hydroxide formation occur. Both reactions require OH⁻ for forward reaction rate (see Equations 6-7).

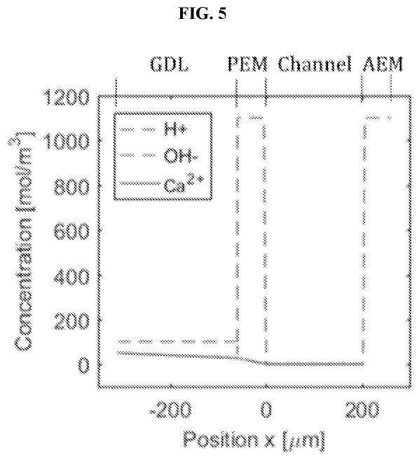

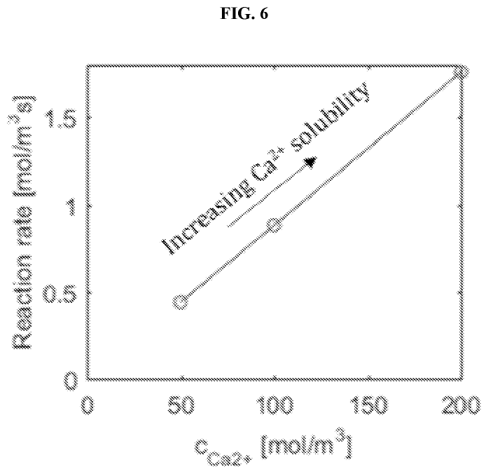

FIGS. 5 and 6 show preliminary results generated by the model for cell potential of 1.5 V. FIG. 5 illustrates proton, hydroxide, and calcium ion distributions within the gas diffusion layer (GDL), polymer electrolyte membrane (PEM), channel, and anion exchange membrane (AEM). Ca²⁺ ions diffuse through the PEM and react with OH⁻ in the channel, where the Ca²⁺ concentration is about 0 M. Ca²⁺ solubility and diffusivity are limiting factors to achieve higher reaction-rates. The model shows no dependency of Ca(OH)₂ generation with electrochemical current density. The model indicates that Ca(OH)₂ can be generated at higher reaction rates.

As shown in FIG. 6, a direct method for increasing reaction rate is to increase Ca²⁺ solubility, as the reaction rate is directly proportional to Ca²⁺ availability. Dissolution of CaCO₃ can be improved by an order of magnitude (e.g., from 5 to 50 g/L) using a strong acid feed solution, such as 1 M HCl. In the model, the channel width is set to 200 μm, which introduces Ohmic loss. Because diffusivity scales with L²/t, reducing the channel length by half will increase diffusivity by 4. A so-called “zero-gap” cell that is commonly used in chlor-alkali processes and PEM electrolyzers is not feasible here, as the channel between the membranes is needed to precipitate the Ca(OH)₂ product. However, it is possible to transform the channel into a mesh, as is done in chlor-alkali technology to help improve structural stability of the electrolyzer.

Methods for Producing Cement Clinker

In another aspect, the present disclosure relates to a method of producing a cement clinker, comprising, consisting essentially of, or consisting of: (a) providing a calcium hydroxide produced according to any of the methods discussed above; and (b) combining the calcium hydroxide with oxides and/or silicates to produce the cement clinker. In some embodiments, (a) providing a calcium hydroxide produced according to any of the methods discussed above method comprises: (i) dissolving a calcium precursor in a first solution in contact with a first electrode to produce Ca²⁺ ions; (ii) transporting the Ca²⁺ ions across a first membrane from the first solution into a second solution using a first electrochemical potential; (iii) producing hydroxide ions at a second electrode; (iv) transporting the hydroxide ions across a second membrane into the second solution using a second electrochemical potential; and (v) precipitating calcium hydroxide from the second solution.

The methods of the present disclosure offer several advantages that make them attractive as methods for commercial cement production. A commercial cement plant, on average, produces 1,000,000 tons of cement per year. Thus, for the electrolyzer process to be commercially viable, an electrolyzer-based plant must be capable of producing sufficient amounts of Ca(OH)₂ to produce enough clinker to in turn produce 1,000,000 tons of cement per year. The clinker-to-cement production ratio is typically 0.9 to 0.97 tons of clinker per ton of cement produced. CaO in the clinker is 64.4% by weight. Thus, assuming 1:1 conversion of Ca(OH)₂ to CaO with water during calcination, 644,000 tons/year of Ca(OH)₂ is required to compete with convention commercial cement plants.

By analogizing to conventional chlor-alkali manufacturing processes, the methods and apparatuses of the present disclosure are capable of producing Ca(OH)₂ at the required scale. The methods and apparatuses of the present disclosure and convention chlor-alkali processes and systems for NaOH production have several similarities: (1) both processes use salts as inputs—in the present methods, CaCO₃ is an input for producing Ca(OH)₂, and in chlor-alkali processes NaCl is an input; (2) in both processes, dissociated cations combine with hydroxide ions in a flow-channel to form Ca(OH)₂ and NaOH, respectively; and (3) both methods produce gaseous by-products; and (4) Ca(OH)₂ and NaOH are collected. Chlor-alkali systems in industrial use are capable of producing NaOH at a capacity of about 237,000 to 320,000 metric ton (mt) per year. From this basic analysis we can see that conventional cement production plants and industrial electrolysis processes operate at similar scales of production. So electrochemical systems for Ca(OH)₂ production should be possible at the required scale.

In terms of energy input, calcination of calcium carbonate to produce clinker is similar in energy intensity to Ca(OH)₂ production in electrolyzer. However, electrochemical methods for producing Ca(OH)₂ do not require fossil fuels as a source of energy, and renewable energy sources may be used. In conventional cement production, the calcination kiln must reach a temperature of approximately 1450° C., which requires burning of fossil fuels. In comparison, for Ca(OH)₂ production, electricity input may be provided by renewable energy sources, such as wind or solar. Another advantage of the methods described herein is lower temperature requirements. For industrial scale electrolysis processes (e.g., chlor-alkali processes for NaOH production), the energy input requirement is about 2100-2400 kWh/ton, which translates to approximately 7.5-9.4 GJ/ton. This energy input is on the same order of magnitude as that needed to produce a ton of clinker.

Still further, a cement plant is generally constructed in location where limestone deposit is available. Thus, cement production implies certain geographical restrictions, which are alleviated by use of the methods for production of Ca(OH)₂ disclosed herein.

### EXAMPLES

### Example 1. Production of Ca(OH)₂ by Electrochemical Methods

Electrolyzers were designed to validate modeling results discussed above and to experimentally determine the rate of Ca(OH)₂ production with varied electrolyzer current density, temperature, anode flow-rate, pH and other experimental conditions. Ca(OH)₂ production was tested in 5 and 50 cm² reactors with a flow-through channel in-between for the product calcium hydroxide precipitation and removal. The volume of the reactor is not limited by the amount of Ca(OH)₂ precipitation. In addition to calcium hydroxide precipitation, hydrogen generated on the anode is a desirable by-product of the electrochemical water splitting.

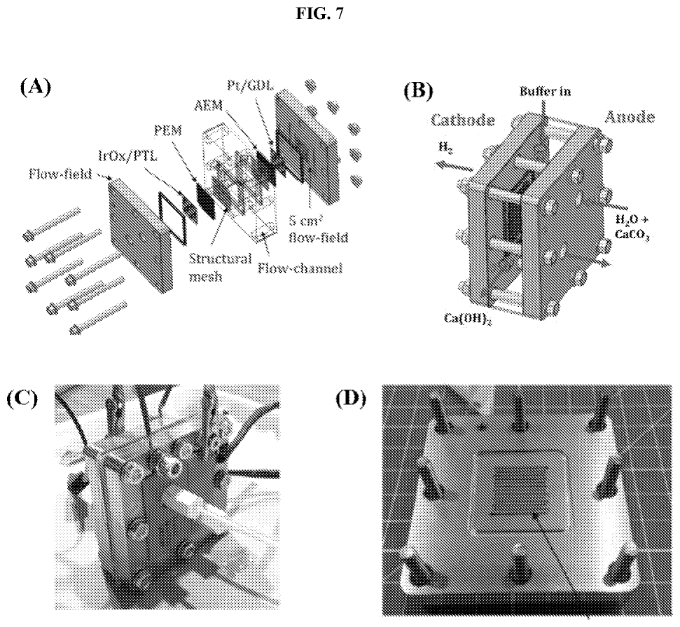

FIG. 7 illustrates the design and assembly of a 5 cm² electrolyzer for CaCO₃ conversion into Ca(OH)₂. The electrolyzer includes a serpentine flow-field on the anode and cathode for reactants, and products distribution over the active area. On the anode side, the flow-field plate is made of Ti to withstand high, applied potentials. Next to the anode gas-flow distribution plate is a sintered Ti layer, which is also used in conventional PEM electrolyzers. On top of the Ti, an IrOx (e.g., IrO₂) layer and NAFION® ionomer are deposited as catalyst layer. On the cathode side of the electrolyzer, only gaseous product (e.g., H₂) is evolved, and there is no water or liquid feed. A gas diffusion layer (GDL) is placed next to a stainless-steel flow-distribution plate, which is coated by Pt/C with alkaline ionomer to ensure that the local pH within the cathode catalyst layer is alkaline. The catalyst layer is in contact with AEM, which is facing the channel on the other side. GDL is highly hydrophobic to prevent electrolyte buffer solution within the channel to leak into the cathode compartment. This liquid can block H2 from leaving the cathode compartment.

The main purpose of the flow channel is to provide a salt solution with high ionic strength to enable Ohmic contact between anode and cathode but at the same time to carry out Ca(OH)₂ precipitate from the channel. In an embodiment, the buffer solution in the channel is 0.1 M KCl. In some embodiments, Ca(OH)₂ is collected at the bottom of the channel. FIGS. 7C and 7D show an assembled and disassembled electrolyzer, respectively, operating at 60° C. and connected to potentiostat for measurements. Further details on the electrode and cell preparation are discussed below.

Electrode Preparation. For the anode, unsupported iridium oxide catalyst was mixed with ionomer (NAFION®) and a mixture of ispropanol and water to form an ink. The ink was deposited via tape casting on a piece of transfer paper and then decal on a NAFION® 212 membrane on one side to obtain the anodic half-CCM (catalyst coated membrane). For the cathode, the preparation method was different, depending on the intended electrochemical reaction. For Configuration 1, 40% Pt/Vulcan carbon was mixed with SUSTAINION® and ethanol to produce the ink, and after tape casting the ink was transferred on a Fumasep FAS-50. For Configuration 2, the ink was instead composed using copper nanoparticles, which were mixed with SUSTAINION® and ethanol.

CellPreparation. The two flow plates of a Dioxide Materials CO₂ reduction cell, the cathode and anode, were made from 316 stainless steel and titanium, respectively. The flow plates were cleaned in isopropanol (Millipore Sigma) and deionizied water (MilliQ). Referring to FIG. 7A, the cell was then assembled as follows: from the anode plate, a 5 cm² square porous transport layer (PTL) composed of sintered titanium is layered on top of the serpentine distributor, with a custom cut gasket of fiber reinforced PTFE to prevent leaking. The corresponding anode half-CCM was then stacked on top with the catalyst layer facing the titanium mesh of the anode. A spacer was then aligned on top of the PEM using the fixture screws. Subsequently, the cathode side was assembled with the cathode half-CCM first and the 5-cm² gas diffusion layer (GDL) with microporous layer (Freudenberg H23C6). The GDL was then closed into a fiber reinforced PTFE gasket and the cathode plate was put in place. The cell was closed using screws with a torque of 9 N·m.

Cell Operation. The cell was operated at 50° C., and the temperature was controlled using adhesive heaters (Dioxide Materials) controlled by a PID with a K-type thermocouple. Current and voltage were controlled using a Keithley 2206B-30-108 power supply. For the reactant and product management, the cell was operated for Configuration 1 and Configuration 2 as follows:

Configuration 1 (Bipolar Water Electrolysis): The cell was operated using a peristaltic pump (Cole-Palmer) using two different liquid closed loops: the anode feed composed of 1M HCl solution saturated with CaCO₃ (until solid precipitate is observed); and the buffer feed, composed of saturated KCl, which is flown through the spacer, in between the two membranes. The cathode side was left in air.

Configuration 2 (CO₂ Electrolysis): The cell operation was similar to that described for Configuration 1, but at the cathode side, a CO₂ (99.9995%, Airgas) mass flow was fed to the anode using a MKS flow meter and was fed humidified (over-saturated) using a bottle saturator (Fuel Cell Technologies) kept at a temperature of 60° C.

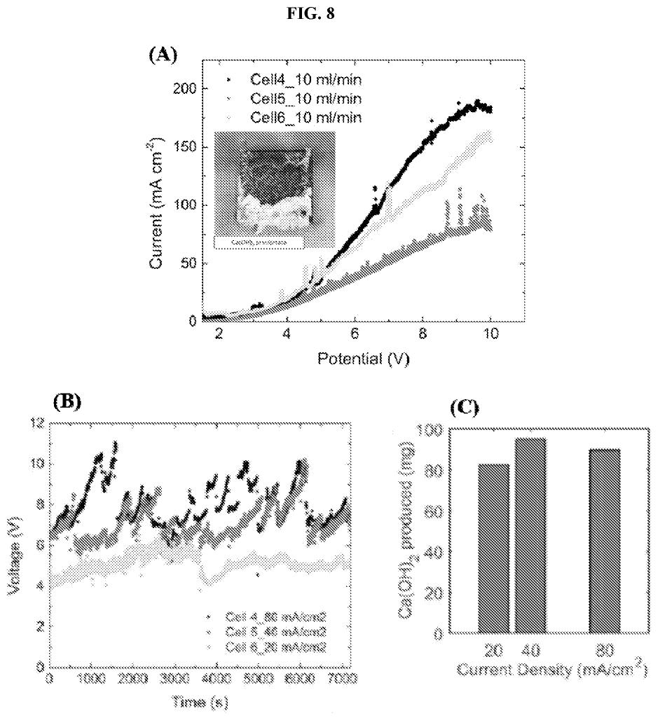

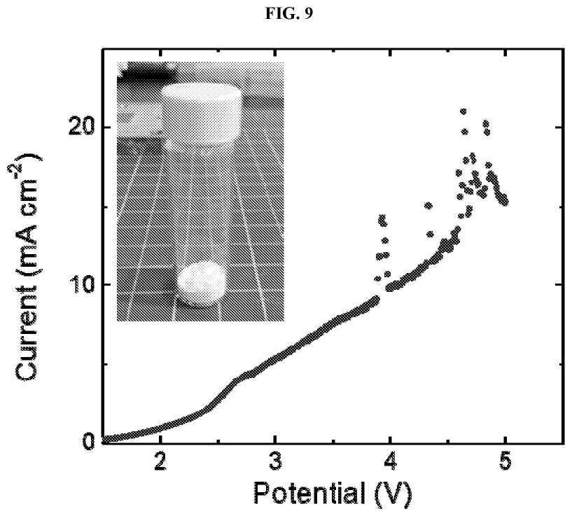

Performance Characterization. Referring to FIGS. 8 and 9, cell performance was evaluated using linear sweep voltammetry, sweeping the potential of the cell from 0 to 10 V (Configuration 1) or 0 to 5 V (Configuration 2) at 10 mV/s. Moreover, the cell was operated at constant current for several hours, to collect sufficient mass of precipitate to enable analysis and weighing for yield calculation. See insets, FIGS. 8 & 9. Electrochemical impedance spectroscopy was used to probe the ohmic resistance of the cell, to evaluate the ionic and electronic contact between the different layers.

FIG. 8 also illustrates the results generated with a 5 cm² bipolar membrane electrolyzer corresponding to Configuration 1. Cell 4 was operated at 80 mA/cm²; Cell 5 was operated at 40 mA/cm²; and Cell 6 was operated at 20 mA/cm² but at 40° C. instead of 60° C. Each cell was operated at constant current density for 2 hours. Ca(OH)₂ precipitation at the cathode side of the cell after anode is also shown in FIG. 8. This product ranged from 80 to 95 mg production per 2 hours. Thus, the preliminary data confirms theoretical and modeling observations that Ca(OH)₂ formation in electrolyzers does not depend on current density, and the Ca(OH)₂ yields indicate that this process could be scaled up to a larger cell or stack of cells to produce Ca(OH)₂ at a commercially-viable scale.

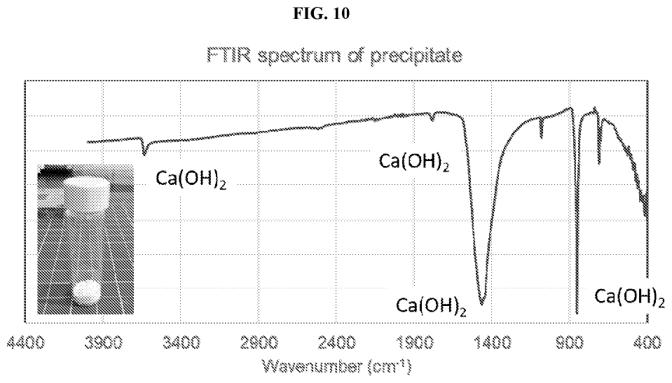

Precipitate Characterization. Referring to FIG. 10, the precipitate collected from the cell was characterized by Fourier Transform Infrared Spectroscopy (FTIR). For example, the FTIR spectrum for the precipitate collected from the Configuration 2 cell (CO₂ electrolysis) shows that the precipitate exhibits characteristic FTIR peaks for Ca(OH)₂. See M. Galván-Ruiz et al. Characterization of Calcium Carbonate, Calcium Oxide, and Calcium Hydroxide as Starting Point to the Improvement of Lime for Their Use in Construction, 21 J. MATER. CIV. ENG'G 694-98 (2009).

### Example 2. Production and Analysis of Concrete

Aalite, belite and cement clinker from Ca(OH)₂ will be produced according to the methods discussed above, using an embodiment of the apparatus discussed above, and analyze the formed phases and particle morphologies and sizes will be analyzed. The clinker hydration reactions, microstructure development, mechanical strength, and durability (of pastes and mortars) will also be analyzed and compared with conventionally manufactured OPC.

Cement Synthesis and Analysis. To synthesize cement or its major constituents, the relevant high-temperature phase equilibria will be used to understand and determine the governing factors of the bulk compositions for OPC, the clinker synthesis conditions, and the phase contents and microstructure of the material. Alite, belite, and OPC clinker will be synthesized in an electric muffle furnace in platinum crucibles, by heating mixtures of appropriate composition at temperatures where the phases are stable according to the phase equilibria.

Finely-ground and well-mixed combinations of crystalline oxides (e.g., quartz (SiO₂) and Ca(OH)₂) collected from the apparatus will be prepared for high-temperature synthesis. C3S will be synthesized by mixing the precursors with a Ca/Si molar ratio of 3:1, followed by filtering, calcinating, and rapid cooling to a kinetically stable temperature. Quenching may be necessary to avoid dissociation of C3S back to C2S and CaO, as C3S is only metastable at temperatures below 1250° C. Foreign ions such as Al³⁺, Fe³⁺, and Mg²⁺ can be incorporated to produce a stable C3S at room temperature. C2S is a stable phase from room temperature up to its melting point at 2130° C. The mixtures are based on the stoichiometric mix with Ca/Si molar ratio of 2:1, and the β-form C2S is stabilized with B₂O₃.

Portland cement clinker formation in the CaO—Al₂O₃—Fe₂O₃—SiO₂ system is based on previously-studied equilibria. Proportioning of the raw materials for synthesizing OPC clinker will follow the Bogue calculation. This method uses the known quantities of oxides from the raw materials together with established phase diagrams for the oxide systems to calculate the potential phase compositions present in the synthesized OPC. Besides the electrolysis-produced Ca(OH)₂, the input materials containing other oxide systems include reagent-grade oxides such as corundum and hematite, as well as natural raw ingredients such as ground quartz and clay or industrial wastes such as fly ash. The actual phase compositions in the synthesized cement will be experimentally confirmed. Afterwards, the samples may be ground to a desired fineness, because the specific surface area by Blaine's method affects the clinker reactivity. The significance of this process and results is three-fold: (1) it generates fundamental understandings on the efficacy of OPC synthesis methods and process from the electrolysis-produced Ca(OH)₂; (2) it leads to various possible combinations of raw materials (natural and wastes) for synthesizing OPC from Ca(OH)₂ made by the new manufacturing method; and (3) by comparing the predicted and actual phases in the synthesized OPC, it generates new insights on the accuracy of the widely adopted Bogue method when applied to the OPC produced from the proposed method.

The phase contents and distributions of alite, belite and OPC clinker synthesized in this manner will be analyzed using x-ray diffraction (XRD) and scanning electron microscopy (SEM), to be compared with commercially available samples manufactured through the conventional approach. XRD will be performed on powder samples, and the resulting peaks will determine the quantitative phase composition in the powder. The analysis of XRD data can be performed using Rietvelt refinement or the full-pattern approach.

Phase distribution in clinkers will be studied using SEM combined with XRD with a method similar to ASTM C 136534. Powder samples will be mounted in a medium-viscosity epoxy to preserve the microstructure, and then the sample cross-sections will be examined by backscattered electron imaging and energy dispersive spectroscopy. Differential thermal analysis and differential scanning calorimetry integrated with thermal gravimetric analysis will be also performed to follow the transformation of phases with temperature during cement synthesis. The combined analysis will determine the needed temperature required for forming various phases and proper contents in cement, compare the phase composition in the cements derived from different methods and precursors, and enable optimal proportioning and processing.

Cement Characterization. To ensure, widespread adoption, it is important for cement synthesized using Ca(OH)₂ prepared according to the present disclosure to achieve satisfactory performance similar to conventionally manufactured OPC. The performance includes hydration reaction kinetics, microstructure and porosity, mechanical strength development, dimensional stability, and durability.

The early-age hydration of the synthesized alite, belite and cement will be investigated by isothermal calorimetry. This method measures the thermal flux released during clinker hydration, giving vital information on the hydration reaction rates of the phases and the degree of hydration with time, which can be related to microstructure and strength development. The hydration reaction progress will also be investigated using XRD to quantify the growth of crystalline hydration products in dried and ground cement powder samples. Thermal analysis will be performed, giving complementary information to XRD on the quantities of hydrated phases. The early-age hardening and setting time will be measured using the Vicat test to study the effects of phase composition in the synthesized cement.

The microstructure and pore structure of pastes (cement+water) and mortars (cement+water+sand) resulting from the hydration of synthesized cement will be investigated through SEM, X-ray microtomography for 3D quantification of microstructure and phases, and mercury porosimetry for pore size distribution and porosity. The microstructure characterization results are vital for understanding the cement reactivity, mechanical strength development, and durability-related properties such as permeability.

Compressive strength is the most important mechanical property of cement-based materials, as it determines the potential engineering uses and performance in load-carrying structures such as buildings or bridges. Compressive strength development with time depends on the proportions and reactivity of different phases in cement, and the microstructure development resulting from cement hydration. Cubes (50 mm) of paste (cement+water) made with the synthesized cements versus commercially available OPC will be tested under compression and compared for compressive strength over time.

Dimension stability such as early-age autogenous shrinkage is an important property of OPC-based material that can lead to durability issues such as early-age cracking, chloride penetration through cracks and consequent reinforcement corrosion. The long-term durability issues have proved to contribute to the CO₂ emission and energy consumption during infrastructure (e.g., concrete bridges and pavements) life cycle. Therefore, CO₂ reduction through the new electrolysis-based manufacturing approach will be significant only if the resulting cement is proven to have uncompromised durability performance compared to conventional OPC. Early-age autogenous shrinkage and expansion measurements will thus be conducted by measuring volume changes in cement pastes cast into flexible latex molds and immersed in water using Archimedes' principle. The chloride diffusion through the cement mortar depends on the microstructure and pH environment formed from cement phases hydration, and will be studied through chloride solution ponding and chemical analysis of extracted cementitious powders at different chloride penetration depths with time. All results will be compared with conventional OPC.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. An electrochemical method for producing calcium hydroxide, the method comprising:
(a) dissolving a calcium precursor in a first solution in contact with a first electrode to produce Ca²⁺ ions;
(b) transporting the Ca²⁺ ions across a first membrane from the first solution into a second solution using a first electrochemical potential;
(c) producing hydroxide ions at a second electrode;
(d) transporting the hydroxide ions across a second membrane into the second solution using a second electrochemical potential; and
(e) precipitating calcium hydroxide from the second solution.

2. The method of claim 1, wherein the calcium precursor comprises calcium carbonate.

3. The method of claim 2, wherein the first electrode is an anode.

4. The method of claim 3, wherein the first solution has an acidic pH.

5. The method of claim 4, wherein the first membrane is a polymer electrolyte membrane.

6. The method of claim 5, wherein the first electrochemical potential is produced by water electrolysis or chlorine evolution.

7. The method of claim 6, wherein the second electrode is a cathode.

8. The method of claim 7, wherein the second membrane comprises an anion exchange membrane.

9. The method of claim 8, wherein the second electrochemical potential is produced by water electrolysis or carbon dioxide electrolysis.

10. The method of claim 9, wherein the second solution is a salt solution.

11. The method of claim 10, wherein the second solution flows through a channel between the first membrane and the second membrane.

12. The method of claim 11, further comprising:
(f) collecting one or more by-products from the production of the first electrochemical potential or production of the second electrochemical potential.

13. The method of claim 12, wherein the one or more by-products comprise hydrogen gas, carbon monoxide gas, or chlorine gas.

14. The method of claim 13, wherein the first electrochemical potential is produced by oxidation of one or more hydrogenated fuels.

15. The method of any one of claim 14, wherein the one or more hydrogenated fuels comprises methanol, ammonia, hydrazine, or sodium borohydride.

16. The method of claim 14, wherein the one or more hydrogenated fuels is in a liquid state.

17. The method of claim 1, wherein current is supplied to the anode and/or the cathode using a renewable energy source.

18. A method of producing cement clinker, the method comprising:
providing a calcium hydroxide produced according to a method of claim 1; and
combining the calcium hydroxide with oxides and/or silicates to produce the cement clinker.

19. An apparatus for the electrochemical production of calcium hydroxide, the apparatus comprising:
(a) an anode;
(b) a cathode; and
(c) a flow-through channel between the anode and the cathode,
wherein a first membrane or separator is between the anode and the flow-through channel and a second membrane or separator is between the cathode and the flow-through channel.

20. The apparatus of claim 19, further comprising a flow field in contact with a first side of the anode, wherein the flow field comprises an anode inlet and an anode outlet configured to supply a first solution to the anode.

21. The apparatus of claim 20, further comprising a channel inlet and a channel outlet, wherein the channel inlet is configured to supply a flow of a second solution to the channel and the channel outlet is configured to direct the flow of the second solution and precipitated calcium hydroxide away from the channel.

22. The apparatus of claim 19, further comprising a flow field in contact with a first side of the cathode, wherein the flow field comprises a cathode inlet and a cathode outlet configured to supply a third solution to the cathode.

23. The apparatus of claim 19, wherein the first membrane comprises a polymer electrolyte membrane.

24. The apparatus of claim 19, wherein the second membrane comprises an anion exchange membrane.

25. The apparatus of claim 19, wherein the anode comprises a first catalyst.

26. The apparatus of claim 25, wherein the first catalyst comprises IrOx.

27. The apparatus of claim 19, wherein the cathode comprises a second catalyst.

28. The apparatus of claim 28, wherein the second catalyst comprises Pt/C.

29. The apparatus of claim 19, wherein the anode and/or the cathode comprises a gas diffusion layer.

30. The apparatus of claim 19, wherein the channel has a length, measured between the first membrane or separator and the second membrane or separator, of about 100 μm to about 10 mm.
